(19) United States
(12) Patent Application Publication
(10) Pub. No.: US 2009/0015723 A1
(43) Pub. Date: Jan. 15, 2009

(54) MEDIA SWITCHING DEVICE

(75) Inventor: Tohru Doumuki, Yokohama (JP)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION OF JAPAN, Tokyo (JP); SONY ELECTRONICS, INC., Parkridge, NJ (US)

(21) Appl. No.: 12/141,437

(22) Filed: Jun. 18, 2008

Related U.S. Application Data
(60) Provisional application No. 60/936,056, filed on Jun. 18, 2007.

(51) Int. Cl. H04N 5/44

(52) U.S. Cl. 348/725; 348/E05.096

(57) ABSTRACT

A High Definition Multi-media Interface (HDMI) switch emulating a Consumer Electronic Control (CEC) source device. A source device may be coupled to the HDMI switch, wherein the source device is incompatible with CEC protocol. Configuration information, e.g., a logical address corresponding to a port which couples the source device to the HDMI switch, may be determined and the result may be stored. In response to a user selection of a source device, the sink device may send a CEC message to the source device. The HDMI switch interprets the CEC message on behalf of the source device, e.g., by using the logical address. The switch then creates a logical connection between the selected source and the sink device. In this way, source devices connected to the switch are transparently visible and selectable from the sink device's menu and therefore provide the same usability as CEC devices.

### RELATED APPLICATIONS

This application claims the benefit and priority to a provisional application Ser. No. 60/936,056 with attorney docket No. SONY-50×9001.01.PRO, inventor Tohru Doumuki, entitled “HDMI SWITCHING DEVICE” that was filed on Jun. 18, 2007 and assigned to the same assignee. The above-cited provisional application is incorporated herein in its entirety.

### TECHNICAL FIELD

Embodiments of the present invention relate to the field of electronics. More particularly, embodiments of the present invention relate to connection mechanisms for high definition multi-media devices.

### BACKGROUND ART

The High Definition Multimedia Interface (HDMI) facilitates uncompressed digital signals for high picture and sound quality in the media arts. Moreover, the HDMI cable provides a single cable for video, audio and control signals that enable communication between electronic devices, e.g., a source device and a display or output device. Thus, an HDMI cable may be used to carry video, audio and control signals, thereby eliminating the need to use separate cables. HDMI cables are also compatible with personal computer (PC) interfaces and HDMI cables automatically display and match for resolution, format and aspect ratio. As a result, many electronic devices are now HDMI enabled and HDMI is becoming a standard interface between many consumer digital video products and display devices, e.g., television sets.

Increasing the number of electronic devices that are HDMI enabled, increases the number of input ports required by a sink device, e.g., a television set. As such, the number of input ports on a television becomes more important and considered a key feature. Unfortunately, the number of input ports on an electronic device such as a television set is limited due to physical constraints.

One conventional solution to increase the number input ports for HDMI coupling has been to use an HDMI switch device. The HDMI switch includes multiple inputs and an output port. For example, the HDMI switch may have three input ports that supports up to three source devices and the output port is connected to the television set.

Unfortunately, source devices connected to the HDMI switch are not viewed as separate source devices if the source devices are not Consumer Electronics Control (CEC) protocol enabled. In other words, a sink device such as a television set only detects the HDMI switch being connected to it, thereby the television set is incapable of providing a selectable list of source devices that may be selected through the television. As a result, each time a user wishes to switch between the switched source devices, the user must manually, e.g., via buttons on the HDMI switch, select the desired source device. Furthermore, the user needs to know the configuration of how the source devices are connected to a sink device, e.g., which port of the sink device is connected to which port of the HDMI switch and which switch ports are connected to which source devices.

In one conventional system, the above mentioned disadvantages may be addressed by using a CEC protocol. In general, CEC is a protocol over HDMI that may be used to discover and control devices that are connected. For example, a television set may use CEC signals to list the name of source devices connected to the television set, their model number, type, etc. Furthermore, CEC signals may be used to send and receive control signals, e.g., turning the source device on/off. As a result, CEC signals provide more convenience since the user is able to use a remote control for controlling a source device without the need to manually control the connected switch. Unfortunately, the number of electronic devices capable of supporting CEC signals is limited. The majority of source devices do not support CEC protocol.

### SUMMARY

Accordingly, a need has arisen to increase the number of input ports usable for a sink device, e.g., a television set, for HDMI coupling such that source devices can be viewed and selected separately by the sink device. Moreover, a need has arisen to switch between source devices without requiring a user to manually switch between the source devices, e.g., manually using an HDMI switch. Furthermore, a need has arisen to extend the above mentioned needs for source devices that are incompatible with Consumer Electronics Control (CEC) protocol. It will become apparent to those skilled in the art in view of the detailed description of the present invention that the embodiments of the present invention remedy the above mentioned needs.

In one embodiment of the present invention an HDMI switch operable to be connected to a sink device is used for responding to a CEC signal on behalf of a connected source device that is not compatible with CEC protocol. As a result, the HDMI switch provides some emulation of a CEC source device. In this example, it is assumed that the television set is the sink device and is CEC compatible.

In one exemplary embodiment, an HDMI switch couples a sink device, e.g., a television set, to a plurality of source devices, e.g., a tuner, a receiver, a recorder, a player, etc. During setup, configuration information regarding the source devices is provided by the user. For example, a user may enter the port number that couples the HDMI switch with a particular source device, the name of the source device, the type, the model number, etc. It is appreciated that the configuration information may be supplied via a sink device, e.g., a television set, for updating the device list stored therein. The HDMI switch may have a display, a transmitter, an input, memory component, a plurality of ports and a processor. Thus, in another embodiment the configuration information may be entered and processed by the HDMI switch and then communicated to the television set.

In one exemplary embodiment, a user may navigate a graphical user interface (GUI) rendered by the sink device and provided by the sink device and/or the HDMI switch to supply the configuration information regarding source devices. For example, a drop-down menu for port numbers, a pop-up window for the type of source devices, etc., may be displayed such that a proper selection can be made by the user of the source device. It is appreciated that the GUI may be provided by the HDMI switch to the sink device or it may be resident on the sink device itself. It is further appreciated that the HDMI switch may be integrated within the sink device.

According to one embodiment, configuration information is provided by the user to the HDMI switch and is stored for later use. After the initial setup, a remote control may be used to interact with an on-screen GUI of the sink device to switch to a desired source device, e.g., a tuner. As a result, remote switching between source devices is possible. The sink device is capable of communicating CEC commands to the switch device which switches to a selected source and also may respond on behalf of the source device, e.g., an acknowledgement CEC signal. In other words, a CEC signal generated by the sink device is interpreted and responded to by the HDMI switch, thereby emulating a source device with CEC generating capability even though the source device by itself is incompatible with CEC protocol. In this fashion, the switch is able to make the correct logical connection between the selected source device and the sink device.

Accordingly, source devices that are incompatible with CEC protocol can be viewed and controlled individually by the sink device. Remote switching between source devices is possible because source devices can be viewed and selected individually via the sink device and selection information, via a CEC command, can be communicated to the switch device. As a result, the need for the user to manually switch between source devices by toggling a switch on the HDMI switch device is eliminated. In other words, source devices may be controlled using the sink device even though the particular source device may be incapable of processing CEC signals.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 shows an exemplary system in accordance with one embodiment of the present invention.

FIG. 2 shows an exemplary HDMI switch in accordance with one embodiment of the present invention.

FIG. 3 shows an exemplary output display on a sink device during a setup process in accordance with one embodiment of the present invention.

FIG. 4 shows an exemplary system for switching between source devices in accordance with one embodiment of the present invention.

FIG. 5 shows an exemplary flow diagram for interfacing a sink device and a source device in accordance with one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

The term “computer-readable medium” as used herein refers to any medium that participates in providing instructions to processor for execution. Such a medium may take many forms, including but not limited to, non-volatile media, volatile media, and transmission media. Non-volatile media includes, for example, optical or magnetic disks, such as storage device. Volatile media includes dynamic memory, such as main memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read. Various forms of computer readable media may be involved in carrying one or more sequences of one or more instructions to processor for execution. For example, the instructions may initially be carried on a magnetic disk of a remote computer. The remote computer can load the instructions into its dynamic memory and send the instructions over a telephone line using a modem

### Media Switching Device

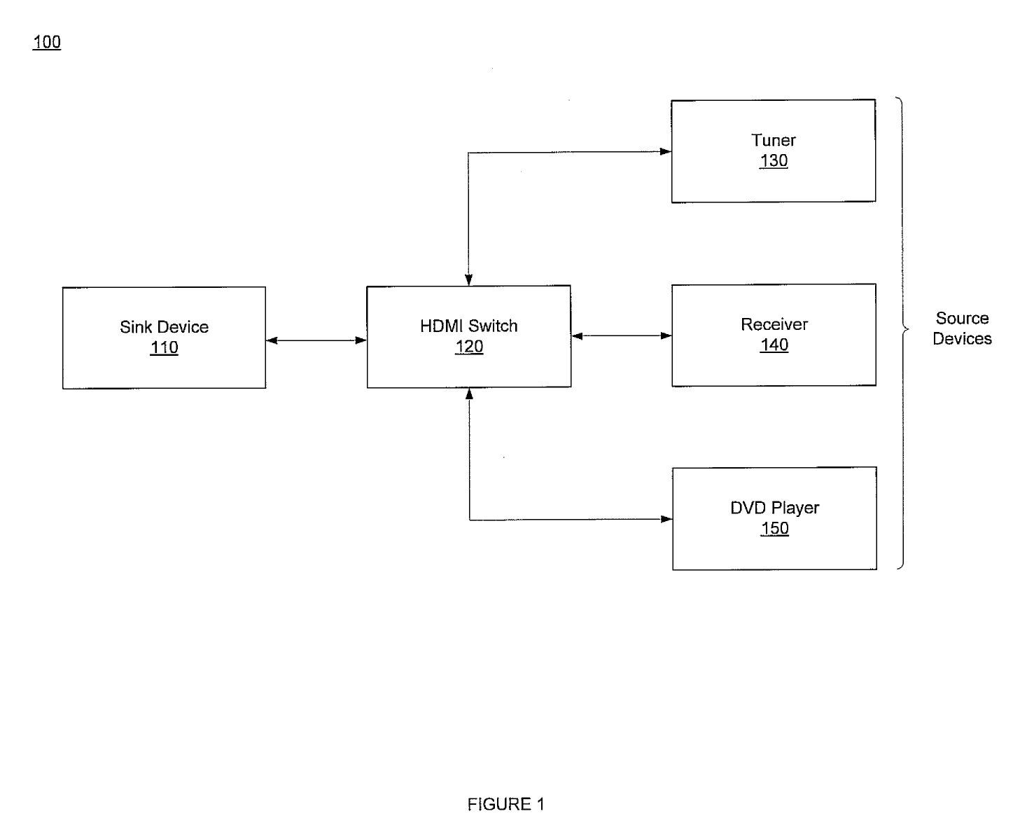

Referring now to FIG. 1, an exemplary electronic system 100 in accordance with one embodiment of the present invention is shown. The exemplary system 100 comprises a sink device 110, a high definition multimedia interface (HDMI) switch 120 and a plurality of source devices, e.g., a tuner 130, a receiver 140 and a DVD player 150 for instance. These source devices may be high definition source devices. The sink device 110 may be a display device such as a television set but could be any device capable of rendering audio and/or video.

The HDMI switch 120 couples the plurality of source devices to the sink device 110. It is appreciated that more than one sink device may be used. Thus, use of one sink device is exemplary and should not be construed as limiting the scope of the present invention. It is assumed that the sink device 110 may be limited in input port capacity and uses switch 120 to expand that capacity.

According to one embodiment of the present invention, at least one of the plurality of source devices is HDMI compatible but not compatible with the Consumer Electronics Control (CEC) signal protocol. For illustration purposes it is presumed that the receiver 140 is in compliance with HDMI requirements but incompatible with CEC protocol. It is appreciated that the source device, e.g., the receiver 140, that is incompatible with CEC protocol may be coupled to the HDMI switch 120 via an HDMI cable and/or wireless HDMI. However, it is also appreciated that the source device that is incompatible with CEC protocol, e.g., the receiver 140, may be coupled to the HDMI switch 120 without utilizing an HDMI cable and/or wireless HDMI. For example, an RCA cable or component cable or coaxial cable may be used to couple the receiver 140 to the HDMI switch 120. It is appreciated that the HDMI switch 120 may be coupled to the sink device 110 via an HDMI medium, e.g., HDMI cable, wireless HDMI, etc. It is further appreciated that according to one embodiment, the HDMI switch 120 may be integrated within the sink device 110 but for illustration purposes is shown as separate.

The HDMI switch 120 may comprise a plurality of ports for coupling the plurality of source devices to the sink device 110. As a result, the number of source devices that are available to the sink device 110 is increased and not limited to the physical constraints of the sink device 110, e.g., number of physical input ports.

A user may enter information that may be used by the HDMI switch 120 to selectively switch between the source devices. Moreover, the HDMI switch 120 may respond to a CEC signal from the sink device 110 and may also generate a CEC signal for the sink device 110. A setup procedure is used the first time that a source device is coupled to the HDMI switch 120, wherein the source device is incompatible with CEC protocol. For example, the first time that the receiver 140 is coupled to the HDMI switch 120, the user may enter a setup procedure.

During the setup process and according to one embodiment, the user may enter information regarding each coupled source device. For example, the user may enter the port number that couples the receiver 140 to the HDMI switch 120. Additional information may also be entered that describes the source device. In one exemplary embodiment, the user may enter the type, the model, the manufacturer, etc., of the source device that is coupled to the HDMI switch 120.

In one embodiment, the setup information is entered by the user at the switch device. For example, the HDMI switch 120 may comprise buttons, a display, etc., such that a user can enter the information.

Alternatively, the HDMI switch may be operable to supply user selectable information such that proper selection can be made, e.g., via a user interface. It is appreciated that in one embodiment, the selectable information and/or enterable information may be facilitated via a graphical user interface (GUI) supplied by the HDMI switch 120 and/or the sink device 110 and displayed by the sink device 110. For example, the sink device 110 may be used to display information and a remote control may be used to enter/select source device information regarding the source devices that are coupled to the HDMI switch 120. In one embodiment, the GUI may supply the selectable information and/or enterable information via the display of the HDMI switch 120. Therefore, setup information may be entered directly at the switch 120 or by interfacing with an on-screen GUI at the sink device 110.

After the setup procedure, the supplied configuration information may be stored by the HDMI switch 120. The HDMI switch 120 may generate a CEC signal (to the sink device 110) on behalf of a source device that is not compatible with CEC signal protocol in order to inform the sink device about the existence of the source device. For example, the HDMI switch 120 may respond to a CEC signal from the sink device 110 on behalf of the receiver 140 informing the sink device of the receiver. According to one embodiment, the HDMI switch 120 also is aware of the logical address for the source device, e.g., logical address for the receiver 140, to make the logical connection between the sink device 110 and the selected source device.

As a result of the switch device informing the sink device of the existence of the source devices and their identifications, source devices can be viewed and selected by the sink device 110 as if all of the source devices were CEC compatible. In other words, a source device that is incompatible with CEC protocol may be selectable by the sink device 110 similar to a source device that is CEC protocol compatible.

Accordingly, the name and the information regarding a source device that is incompatible with CEC protocol can be displayed by the sink device 110, thereby enabling the source device to be automatically selected by the sink device 110. As a result, the user no longer needs to manually toggle the switch on the HDMI switch to select source devices. Furthermore, because the sink device 110 displays source devices on-screen, this enables the user to select a source device without the need to keep track of the configuration, e.g., the port that couples the source device to the HDMI switch. Thus, source devices can be selected without manual switching regardless of whether they are compatible with CEC protocol thereby increasing the number of source devices that can be coupled to the sink device.

Once a source device is selected by the sink device, a CEC message is sent to the switch from the sink device and this message identifies the source device. This CEC message is interpreted by the switch which makes a logical connection between the selected source device and the sink device.

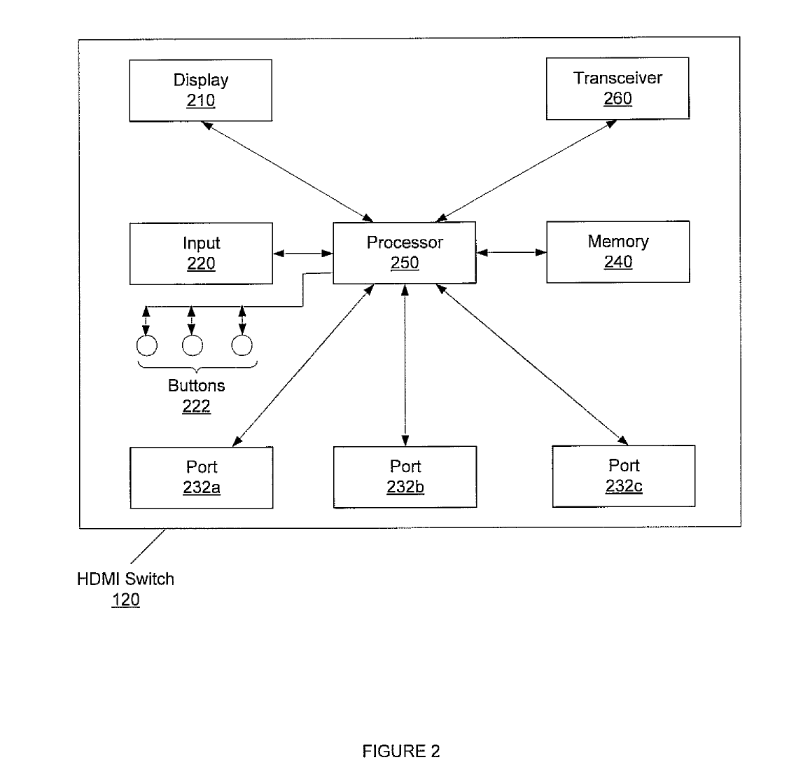

Referring now to FIG. 2, an exemplary HDMI switch device 120 in accordance with one embodiment of the present invention is shown. According to one embodiment, the HDMI switch device 120 optionally comprises a display 210, an optional input 220, a plurality of buttons 222, a plurality of ports 232a-232c, a memory component 240, a processor 250 and a transceiver 260.

The display 210 may be a flat panel display, e.g., a liquid crystal display (LCD), for displaying information. For example, the display 210 may display a menu that includes the number of ports supported by the HDMI switch 120. It is appreciated that the display 210 may be a touch screen display operable to display as well as receive user inputs by tapping or making contact with the display. For example, the display 210 may display a menu where the user can select an item within that menu by making contact with the desired item. The display 210 may render graphical objects. Graphical objects refer to a text, an image, any combination thereof and/or any portion thereof.

The HDMI switch device 120 may include user input 220. Input 220 may be used to enter/select information. For example, input 220 may be soft buttons disposed on the HDMI switch 120. In one exemplary embodiment, the input 220 may be a voice activation input, a mouse, a keyboard, a keypad mechanical buttons, etc.

In one exemplary embodiment, information may be entered/selected via a plurality of buttons 222. For example, buttons 222 may be used to scroll through a displayable menu on the display 210 and select the appropriate information, e.g., port number. It is appreciated that the buttons 222 may be softbuttons, mechanical buttons, etc.

The HDMI switch device 120 comprises a plurality of ports, e.g., ports 232a through 232c. Ports 232a through 232c may be used to couple the HDMI switch 120 to the plurality of source devices, e.g., the tuner 130, the receiver 140, the DVD player 150, etc. It is appreciated that one of the ports 232a through 232c is used to couple the HDMI switch 120 to the sink device 110. According to one embodiment, the port that couples the HDMI switch 120 to the sink device 110 may be different from the ports that may be used to couple the HDMI switch 120 to the plurality of source devices.

The memory component 240 may be used to store digital information. For example, configuration or setup information regarding the source devices that are coupled to the HDMI switch 120 may be stored. In one embodiment, the configuration information regarding the source devices includes, but is not limited to, the type of source device, the model of the source device, the port that couples the source device to the HDMI switch 120, etc.

The memory component 240 may be a random access memory (RAM) or other dynamic storage device for storing information and instructions to be executed by processor 250. The memory component 240 may also be used for storing temporary variables or other intermediate information during execution of instructions to be executed by processor 250. The memory component 240 may be a read only memory (ROM) or other static storage device for storing static information and instructions for processor 250. It is appreciated that more than one memory component 240 may be used and that the use of one memory component 240 is exemplary and should not be construed as limiting the scope of the present invention.

The transceiver 260 may be used to send/receive signals, e.g., wireless signals, wired signals, CEC protocol signals, etc. In one example, the transceiver 260 may be used to send/receive information between the HDMI switch 120 and a remote control. In one embodiment, the transceiver 260 may be used to send/receive signals between the HDMI switch 120 and the sink device 110. It is appreciated that the transceiver 260 may be HDMI enabled.

According to one embodiment, a user may enter configuration information regarding source devices that are coupled to the HDMI switch 120. As described above, the configuration information (eventually stored in memory 240) may include the type of the source device, the model, the manufacturer, the port which couples the source device to the HDMI switch 120, etc. The information may be entered using touch screen display 120, input 222 such as a mouse, keyboard, voice command and/or via buttons 222 which a user can scroll through a selectable menu.

It is appreciated that in one embodiment, the HDMI switch 120 may generate a graphical user interface (GUI) to be rendered by the sink device 110. Thus, a user may use a remote and/or other means to communicate with the GUI to select/enter the above described information regarding the plurality of source devices coupled to the HDMI switch device 120. It is appreciated that the stored configuration information may alternatively be supplied from the switch device to the sink device, where the sink device generates and renders the GUI.

The processor 250 may use the supplied configuration information, e.g., the port which couples the HDMI switch 120 to the source device, to determine the logical address of each connected and configured source. It is appreciated that the supplied information and processed information, e.g., determined logical address, is stored in memory 240 for subsequent use.

Accordingly, the HDMI switch device 120 can generate CEC messages on behalf of source devices that are not compatible with CEC protocol, enabling the source device to be recognized by the sink device similar to a source device that is capable of generating CEC messages. Thus, the HDMI switch device 120 emulates a CEC enabled source device even though the source device is incompatible with CEC protocol. As a result, a user can control and switch to a desired source device without the need to manually toggle the switch on the HDMI switch device 120. As such, source devices coupled to the HDMI switch device 120 are transparently visible and selectable from the sink device 110 menu, thereby providing similar usability as if source devices were operable to generate CEC messages. Furthermore, emulating a CEC enabled source device eliminates the need for the user to track or remember the port number that couples the source device to the sink device.

Moreover, once a source device is selected, the sink device sends a CEC message to the switch to identify the source device. This causes processor 250 to create a logical connection between the port of the selected source and the port coupling the sink device. Port information is obtained from the memory stored configuration information.

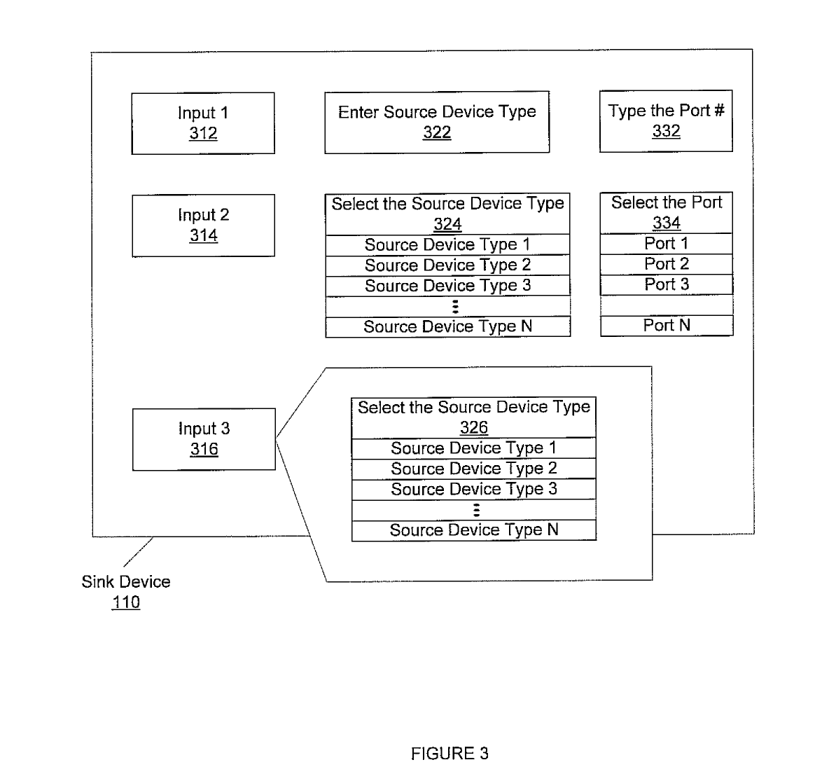

Referring now to FIG. 3, an exemplary on-screen display is shown of a sink device during a setup process in accordance with one embodiment of the present invention. As discussed, a plurality of source devices, e.g., tuner 130, receiver 140, DVD player 150, etc., are coupled to the HDMI switch device 120. After the source devices are coupled to the HDMI switch device 120, a graphical user interface (GUI) may be provided to a user such that a setup process can be performed. According to one embodiment, the GUI may be provided by the HDMI switch device 120. However, it is appreciated that the GUI may be supplied by any device, e.g., the sink device 110. It is therefore appreciated that the HDMI switch device 120 providing the GUI is not intended to limit the scope of the present invention.

The GUI may be provided as a tool enabling a user to record the configuration of source devices and the HDMI switch device 120. Accordingly, it is appreciated that the GUI may be provided in addition or as an alternative to manually and directly configuring this information via the HDMI switch device 120.

The source type may be entered for each port. According to one embodiment, the GUI may provide at least one user modifiable field 322, enabling a user to enter the type of source device, e.g., by typing, using a remote control, voice command, etc. For example, a user may enter the source device type, e.g., receiver 140, which corresponds to input 312 of the sink device 110.

It is appreciated that the source device is coupled to the input 312 of the sink device 110 via the HDMI switch device 120. The GUI may further provide at least one user modifiable field 332, enabling a user to enter the port number of the HDMI switch device 120, e.g., by typing, remote control, voice command, etc., which couples the source device to the HDMI switch device 120. It is appreciated that the source device, e.g., receiver 140, is coupled to input 312 of the sink device 110 via the entered port number of the HDMI switch device 120.

It is appreciated that other similar user modifiable field may be provided for providing additional information regarding the source device and/or how it is coupled to the HDMI switch device 120. It is further appreciated that the modifiable fields presented above are exemplary and are not intended to limit the scope of the present invention. For example, additional modifiable fields or fewer modifiable fields may be provided.

According to one embodiment, the GUI may provide at least one drop-down menu 324, enabling a user to select the type of source device from an existing listing, e.g., by clicking, voice command, tapping on a touch screen, using a remote control, etc. For example, a user may select the source device type, e.g., receiver 140, tuner 130, etc., which corresponds to input 314 of the sink device 110.

It is appreciated that the source device is coupled to the input 314 of the sink device 110 via the HDMI switch device 120. The GUI may further provide at least one user selectable dropdown menu 334, enabling a user to select the port number of the HDMI switch device 120 from an existing listing, e.g., by clicking, voice command, tapping on a touch screen, etc., which couples the source device to the HDMI switch device 120. It is appreciated that the source device, e.g., receiver 140, is coupled to input 314 of the sink device 110 via the entered port number of the HDMI switch device 120.

It is appreciated that other similar user selectable fields may be provided for displaying additional information regarding the source device and/or how it is coupled to the HDMI switch 120. It is further appreciated that the user selectable fields presented above are exemplary and are not intended to limit the scope of the present invention. For example, additional user selectable fields or fewer user selectable fields may be provided.

According to one embodiment, the GUI may provide at least one popup menu 326, enabling a user to select the type of source device, e.g., by clicking, voice command, tapping on a touch screen, using a remote control, etc. For example, a user may select the source device type, e.g., receiver 140, tuner 130, etc., which corresponds to input 316 of the sink device 110.

It is appreciated that the source device is coupled to the input 316 of the sink device 110 via the HDMI switch 120. The GUI may further provide at least one user selectable popup menu (not shown), enabling a user to select the port number of the HDMI switch 120, e.g., by clicking, voice command, tapping on a touch screen, etc., which couples the source device to the HDMI switch 120. It is appreciated that the source device, e.g., receiver 140, is coupled to input 316 of the sink device 110 via the entered port number of the HDMI switch 120.

It is appreciated that inputs 312, 314 and 316 of the sink device may be separate inputs or the same input. In other words, inputs 312, 314 and 316 show input capabilities of the sink device 110. For example, one input may be shown if the sink device 110 has only one input. Similarly, three inputs may be shown if the sink device 110 has three inputs.

It is appreciated that inputs 312, 314 and 316 may similarly be presented by the GUI as a dropdown menu, popup menu, user modifiable field, etc. As such, the user input fields as represented by the GUI is exemplary and should not be construed as limiting the scope of the present invention. For example, in one embodiment the GUI may comprise dropdown menus, popup menus, user modifiable fields and/or any combination thereof. It is appreciated that a GUI may also be rendered after the setup procedure enabling a user to select a desired source device.

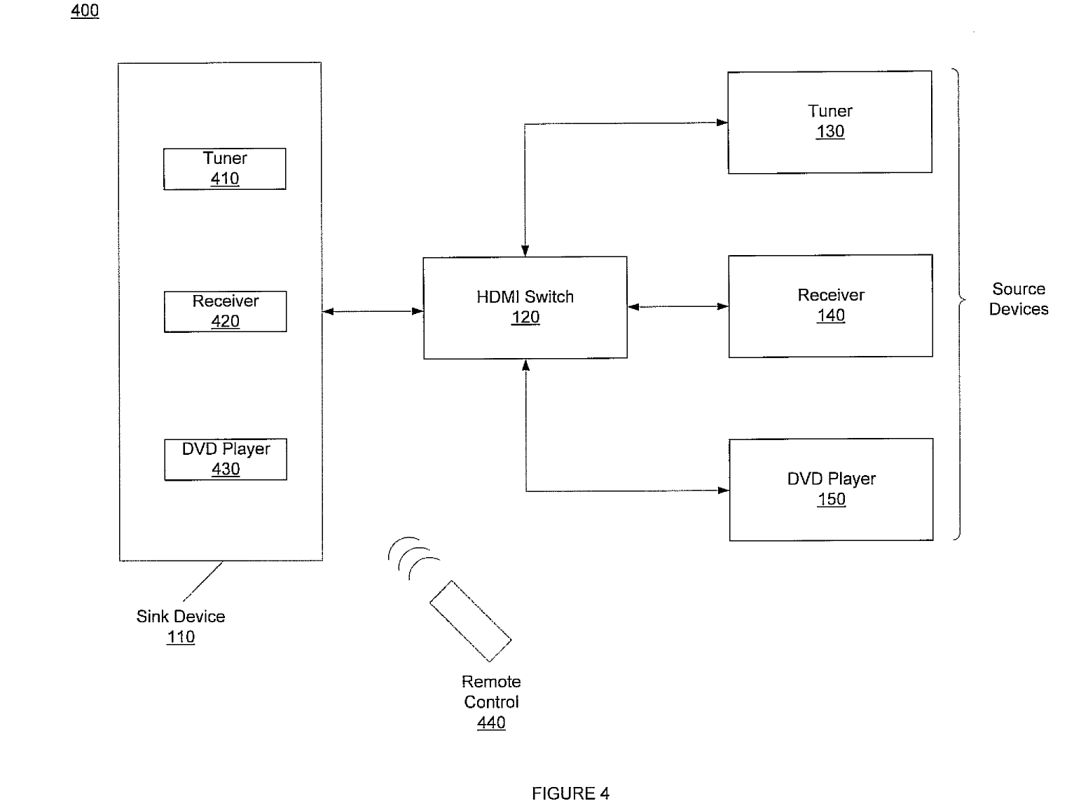

Referring now to FIG. 4, an exemplary system for switching between source devices in accordance with one embodiment of the present invention is shown. Once a setup has been performed and configuration information communicated to the sink device, a user may interact with the sink device 110 as if each source device is CEC enabled even if some and/or all of the source devices coupled to the sink device 110 are not compatible with the CEC protocol.

The switch device generates CEC responses on behalf of source devices that are not compatible with CEC protocol to enable each source device to be viewed on the sink device 110 and selected thereby. In a resource selection mode, the sink device 110 may display items representing these identified source devices. For example, a tuner 410 item or image or label representing the tuner 130 may now be displayed by the sink device 110. Similarly, a receiver 420 item or image or label representing the receiver 140 may now be displayed by the sink device 110. Moreover, a DVD player 420 item or image or label representing the DVD player 150 may now be displayed by the sink device 110. These items are displayed within a GUI of the sink device for source selection.

Accordingly, a user may select a desired source device by selecting a desired on-screen item, e.g., the tuner 410, the receiver 420, the DVD player 430, etc., via a cursor or navigation tool. User interaction and selection may be via a remote control 440 and/or other similar input means.

Once a source device is selected, the television sends a CEC command to the source device which is interpreted by the HDMI switch device 120 instead. The HDMI switch device 120 then establishes the proper logical connection between the television and the selected source device, based on the information from the CEC command. The HDMI switch device 120 may optionally send an acknowledgment CEC command back to the television on behalf of the selected source device.

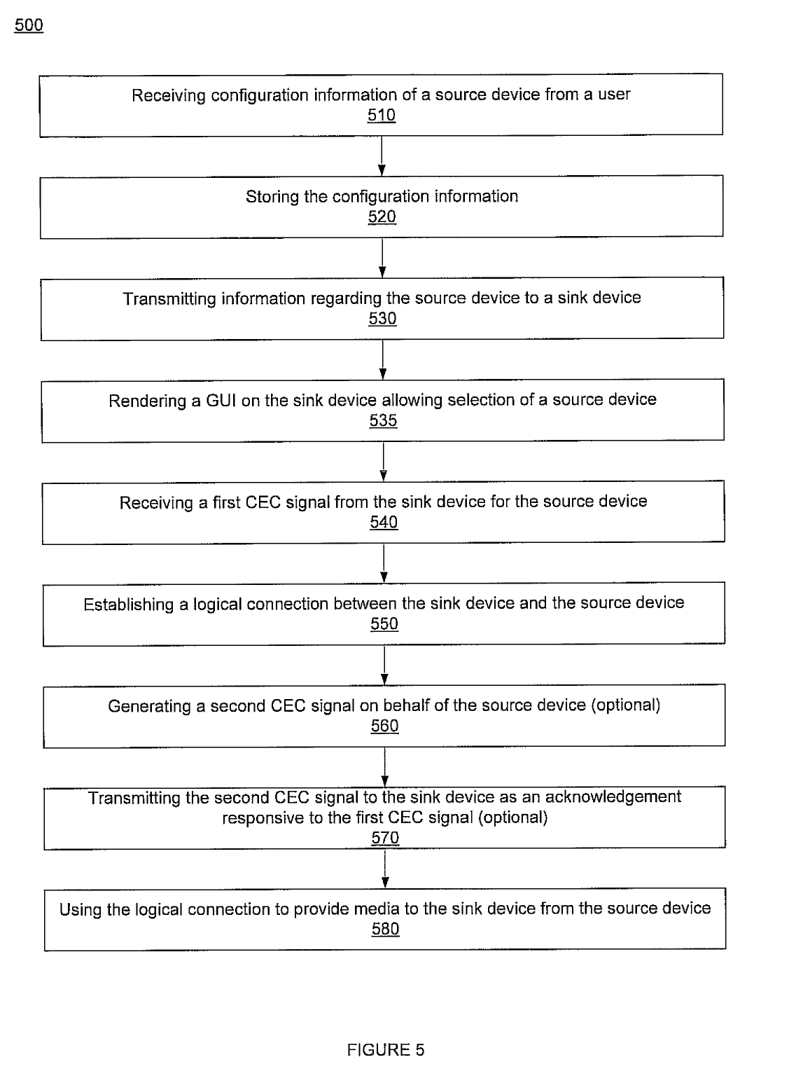

Referring now to FIG. 5, an exemplary flow diagram for interfacing a sink device and a source device in accordance with one embodiment of the present invention is shown. As presented above, a plurality of source devices that are incompatible with CEC protocol may be coupled to a sink device, e.g., a display device, a television set, etc.

At step 510, a configuration or setup information for of a source device may be received. It is appreciated that the configuration information may be received using input components of the HDMI switch, e.g., mechanical buttons, soft buttons, etc. It is further appreciated that the configuration information may be received using a remote control and/or via the sink device. At step 520, the configuration information may be stored in a memory component.

In one embodiment, at step 530, configuration information regarding the source device, e.g., the logical address, the source device identifier, etc., may be transmitted to the sink device. Optionally, step 530 may be performed using CEC commands. It is appreciated that setup 530 may be performed in response to the sink device sending CEC commands to obtain source information. At step 535, the sink device renders a GUI on-screen that lists the source devices connected to the switch. Navigation tools can be used by a user to select one of these source devices.

Upon rendering the GUI enabling the user to select a desired source device, at step 540, the sink device transmits a CEC signal responsive to the user selection. The CEC signal (identify the selected source) is subsequently received by the HDMI switch. At step 550, in response to the received CEC signal, the HDMI switch access the logical address associated with the selected source and automatically establishes a logical connection between the sink device and the selected source device as an acknowledgment signal. Optionally, in one embodiment at step 560, the HDMI switch may generate a response CEC signal on behalf of the source device. At step 570, the response CEC signal, e.g., an acknowledgement responsive to the original CEC signal, may be transmitted to the sink device. It is appreciated that at step 580, the logical connection at the switch may be used to provide media to the sink device from the source device.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of interfacing a sink device and a source device, said method comprising:
receiving a first Consumer Electronic Control (CEC) signal from said sink device for said source device;
in response to said first CEC signal, establishing a logical connection between said sink device and said source device, wherein said source device is not compatible with CEC messages; and
using said logical connection to provide media to said sink device from said source device.

2. The method as described in claim 1 further comprising:
generating a second CEC signal on behalf of said source device; and
transmitting said second CEC signal to said sink device as an acknowledgement responsive to said first CEC signal.

3. The method as described in claim 1 further comprising:
prior to said receiving said first CEC signal, receiving configuration information associated with said source device.

4. The method as described in claim 3 further comprising:
storing said configuration information.

5. The method as described in claim 1, wherein said sink device is a display device.

6. The method as described in claim 1 further comprising:
prior to said receiving said first CEC signal, transmitting information regarding said source device to said sink device, wherein said information is used to display a graphical user interface (GUI) on said sink device, and wherein said GUI displays a representation of said source device and enables selection thereof.

7. The method as described in claim 1, wherein said media is provided to said sink device via a High Definition Multimedia Interface (HDMI) enabled medium.

8. A media switching device comprising:
a plurality of ports for coupling a sink device to a plurality of source devices that are not compatible with a Consumer Electronic Control (CEC) protocol;
a user input device operable to receive configuration information associated with said plurality of source devices;
a memory component operable to store said configuration information associated with said plurality of source devices; and
a processor operable to process data, wherein said processor implements a method of interfacing said sink device and said plurality of source devices, said method comprising:
receiving a first CEC signal from said sink device for one of said plurality of source devices;
in response to said first CEC signal, establishing a logical connection between said sink device and said one of said plurality of source devices; and
using said logical connection to provide media to said sink device from said one of said plurality of source devices.

9. The media switching device as described in claim 8, wherein said method further comprises:
generating a second CEC signal on behalf of said one of said plurality of source devices; and
transmitting said second CEC signal to said sink device as an acknowledgement responsive to said first CEC signal.

10. The media switching device as described in claim 8, wherein said method further comprises:
prior to said receiving said first CEC signal, transmitting information regarding said plurality of source devices to said sink device, wherein said information is used to display a graphical user interface (GUI) on said sink device, and wherein said GUI displays a representation of said plurality of source devices and enables selection thereof.

11. The media switching device as described in claim 8, wherein said media is provided to said sink device via a High Definition Multimedia Interface (HDMI) enabled medium.

12. The media switching device as described in claim 8 further comprising:
a display device operable to render a graphical object.

13. The media switching device as described in claim 8 further comprising:
a transceiver operable to send and receive information.

14. The media switching device as described in claim 8, wherein said user input device comprises a plurality of buttons.

15. A system comprising:
a High Definition Multimedia Interface (HDMI) medium;
a sink device;
a source device that is incompatible with CEC protocol; and
a switch device coupled to said sink device via said HDMI medium and coupled to said source device, and wherein said switch device is operable to receive a first Consumer Electronic Control (CEC) signal from said sink device for said source device, and wherein said switch device responsive to said first CEC signal is operable to establish a logical connection between said sink device and said source device, and wherein said logical connection is operable to provide media to said sink device from said source device.

16. The system as described in claim 15, wherein said switch device is further operable to generate a second CEC signal on behalf of said source device, and wherein said switch device is further operable to transmit said second CEC signal to said sink device as an acknowledgement responsive to said first CEC signal.

17. The system as described in claim 15, wherein said switch device is further operable to receive and store configuration information of said source device prior to receiving said first CEC signal.

18. The system as described in claim 17, wherein said switch device further comprises:
a memory component operable to store said configuration information;
a processor operable to process information;
a display operable to display information;
a user input component operable to receive said configuration information regarding said source device; and
input ports operable to couple said switch device to said source device and said sink device.

19. The system as described in claim 15, wherein said switch device is integrated within said sink device.

20. The system as described in claim 17, wherein said switch device prior to receipt of said first CEC signal transmits information regarding said source device to said sink device, wherein said information is used to display a graphical user interface (GUI) on said sink device, and wherein said GUI enables selection of said source device.
